(19) United States
(12) Patent Application Publication
(10) Pub. No.: US 2026/0257892 A1
(43) Pub. Date: Sep. 3, 2026

(54) LINEAR DRIVE FOR AN ELEVATOR SYSTEM

(71) Applicant: Inventio AG, Hergiswil (CH)

(72) Inventors: Andrea Cambruzzi, Zurich (CH); Christian Studer, Kriens (CH)

(21) Appl. No.: 18/841,693

(22) PCT Filed: Mar. 1, 2023
(86) PCT No.: PCT/EP2023/055093

§ 371 Date: Aug. 27, 2024

(30) Foreign Application Priority Data
Mar. 3, 2022 (EP) 22159867.5

(51) Int. Cl. B66B 11/04; H02K 41/03

(52) U.S. Cl. CPC B66B 11/0407; H02K 41/031

(57) ABSTRACT

An elevator system linear drive includes: a magnetic track having at least one row of permanent magnets each being mounted rotatably about their own axis of rotation in a carrier; a force-transfer member being fixable to one of an elevator shaft and an elevator car with the magnetic track being fixable vice versa, and wherein the permanent magnets in each row are arranged successively in a direction of a displacement axis. The magnetic track and the force-transfer member are displaceable relative to one another in the displacement axis direction and are opposite one another in an overlap region. A permanent magnet located in the overlap region is separated from the force-transfer member opposite it by an air gap. A rotary drive rotates the permanent magnets so that, due to the superposition of the magnetic fields, a traveling field traveling in the displacement axis direction is generated.

### FIELD

The present invention relates to a linear drive for an elevator system. In addition, the invention relates to an elevator system equipped with such a linear drive.

### BACKGROUND

Elevator cars of elevator systems, such as can be used to transport people or goods in multi-story buildings, are usually coupled to an electric motor via suspension elements such as cables or belts. The rotational movement of the drive shaft of the electric motor is converted into a translation of the suspension element and thus of the elevator car along the elevator shaft.

There are also elevator systems whose elevator cars can be moved along the elevator shaft by means of a linear motor. Such a linear motor can comprise a plurality of electromagnets. The strength of the current flowing through the coils of the electromagnet, and thus of the magnetic field generated, is usually limited in order to avoid excessive heat generation.

WO 98/58866 describes an example of an elevator system comprising a linear motor in the form of a switched reluctance machine.

### SUMMARY

There may be a need for a linear drive for an elevator system that enables an increase in force density without excessive heat generation in the elevator shaft. In addition, there may be a need for a correspondingly improved elevator system.

These needs can be met by the subject matter of the advantageous embodiments defined in the following description, as well as the accompanying drawings.

A first aspect of the invention relates to a linear drive for an elevator system. The elevator system comprises an elevator shaft and an elevator car that can be moved in the elevator shaft in the direction of a displacement axis. The linear drive comprises a magnetic track which comprises at least one row of permanent magnets, wherein each permanent magnet is mounted in a carrier so as to be rotatable about its own axis of rotation. In addition, the linear drive includes a force-transfer member made of an electrically conductive material. The magnetic track can be fixed to the elevator shaft, while the force-transfer member can be fixed to the elevator car. Alternatively, the force-transfer member can be fixed to the elevator shaft, while the magnetic track can be fixed to the elevator car. In both cases, the magnetic track and the force-transfer member can be fixed in such a way that:
the permanent magnets of the same row are arranged one behind the other in the direction of the displacement axis;
the magnetic track and the force-transfer member are displaceable relative to each other in the direction of the displacement axis;
the magnetic track and the force-transfer member lie opposite one another in an overlap region, the respectively each permanent magnet located in the overlap region being separated from the force-transfer member opposite it by an air gap.
   In addition, the linear drive comprises a rotary drive which is designed to rotate the permanent magnets about their axes of rotation in such a way that a traveling field moving in the direction of the displacement axis is generated by superposition of the magnetic fields of the rotating permanent magnets, in order to displace the force-transfer member relative to the magnetic track.

A second aspect of the invention relates to an elevator system comprising an elevator shaft, an elevator car that can be displaced in the direction of a displacement axis in the elevator shaft, and a linear drive as described above and below. In this case, the magnetic track is fixed to the elevator shaft, while the force-transfer member is fixed to the elevator car. Alternatively, the force-transfer member is fixed to the elevator shaft, while the magnetic track is fixed to the elevator car.

Electric linear motors are usually based on the generation of a magnetic traveling wave by correspondingly exciting a coil arrangement by means of (multiphase) currents. This principle is comparable to a Mexican wave (“la ola”) of spectators in a stadium: the coil currents pulsate at a certain rate, comparable to standing and sitting spectators, and thus generate a moving magnetic wave. The part of the linear drive containing the coils is usually called the armature, which can be stationary or movable. The other part of the linear drive, hereinafter referred to as the non-armature part, is in electromagnetic interaction with the traveling wave generated by the armature, whereby opposing forces of equal magnitude act on both parts.

Depending on the configuration of the armature, a distinction can be made between synchronous machines, asynchronous machines, or synchronous reluctance machines. For very long stroke applications, synchronous machines are usually too expensive because large amounts of rare earths or copper may be required for the correspondingly long non-armature part. For such applications, rails made of magnetically passive and easily provided material, such as steel or aluminum, and having a simple structure are usually preferred. Designs that are suitable for very long strokes are therefore usually of the asynchronous or synchronous reluctance machine type.

In both cases, the (sinusoidal) traveling wave can be broken down for control purposes into two orthogonal, oscillating components (direct and quadrature currents), which can be varied independently of one another by the resulting broken-down currents, in order to obtain the desired electromechanical behavior of the machine, i.e., propulsive forces and attractive forces can be controlled independently of one another via these orthogonal components. The magnitude of these forces depends to a certain extent on the amplitude of the traveling wave. The force density is therefore limited by the thermal limitations of the armature coils.

The force density of an electrical machine that is based on the traveling wave principle can therefore be limited by the ability of the current-carrying coils to generate a magnetic field. The extent to which the coils can generate a magnetic field is directly proportional to the strength of the current flowing through the coils. For example, if the coils are wound from conventional materials having electrical resistance, the dissipative property of the coils limits the maximum current and thus the torque or force density of the electrical machine.

The long-stroke translational movements can be generated on the principle of direct or indirect driving. The principle of direct driving is based on linear electrical machines that make possible the generation of forces between two magnetic structures of the electrical machine, i.e., stator and rotor, that are separated from one another by an air gap. The force transmission between these two structures occurs without contact, in that the magnetic traveling wave propagates in the direction of the translational movement. In this way, a direct drive can in principle have an unlimited stroke, which is particularly advantageous if the stroke is several orders of magnitude larger than the shortest link of the machine. In practice, however, the force capability of the machine is limited by the available installation space in conjunction with the maximum permissible heat dissipation per unit volume.

The force density can, for example, be increased locally by choosing an indirect drive, which is, however, associated with a greatly reduced stroke. An indirect drive may comprise a rotating machine in conjunction with a mechanical transmission that converts the rotation into a translation. Since the rotating machine is usually spatially separated from the transmission, the heat dissipation of the machine's coils has no significant influence on the transmission. However, frictional heat is generated in the transmission, albeit to a lesser extent. In addition, mechanical transmissions are inherently susceptible to wear and can cause unwanted noise and vibrations.

In the direct drive described above, increasing the force density is generally one of the goals in the design phase of the electrical machine, as it can reduce the amount and mass of material used and increase the cooling capacity correspondingly. In order to increase the force density, cooling methods can be used that keep the temperature of the coils within an acceptable range. However, such cooling methods can be relatively complex.

There are also linear transverse flux machines, flux switching machines, and switched reluctance machines, in which the principle of the magnetic traveling wave is abandoned in favor of an increased force density. However, these approaches may result in increased force ripple and noise. Controlling such machines can be complex.

In order to reduce the power loss in the coils to a minimum, for example superconducting coils can also be used. However, such coils require a carefully shielded cryogenic environment at very low temperatures below 100 K, which can only be implemented in practice with considerable outlay.

The approach proposed here now makes it possible to at least partially overcome the limitations and undesirable effects described above, insofar as the force transmission of the linear drive is based on the principle of the traveling wave, i.e. it is contactless, and the traveling wave is generated by rotating permanent magnets, which can be driven by a rotating electrical machine. On the one hand, this improves heat dissipation. On the other hand, the magnetic field strength can be increased by using permanent magnets instead of coils.

Optionally, the permanent magnets can be driven independently of one another. This makes field-oriented control possible, i.e. propulsion forces parallel to the displacement axis and attraction forces transverse to the displacement axis between the force-transfer member and the permanent magnets can be influenced independently of one another. By means of a correspondingly configured rotary drive, the same orthogonal decomposition of the force components can be achieved as in the case of a conventional synchronous, asynchronous or synchronous reluctance machine, and this with increased force density and reduced power loss.

In other words, rotating permanent magnets, as used in the present approach, are capable of generating higher field strengths with a smaller volumetric footprint in a virtually non-dissipative manner.

The use of permanent magnets also offers the advantage that the attractive forces between the magnetic track and the force-transfer member are maintained even in the event of a power failure. This can increase the operational reliability of the elevator system.

Without restricting the scope of the invention in any way, embodiments of the invention may be considered to be based on the concepts and findings described below.

The permanent magnets can, for example, each be designed in the shape of a rod, in particular a cylinder. In this case, the axis of rotation of a permanent magnet can correspond to its longitudinal or central axis. The permanent magnets can each be magnetized in certain magnetization directions, for example orthogonally to the axis of rotation, and can be positioned relative to one another via the rotary drive in such a way that the magnetization directions of adjacent permanent magnets-in the rotating and/or non-rotating state-are oriented at a defined angle relative to one another. This angle can be kept constant during operation of the linear drive, i.e. while the permanent magnets are rotating, or it can be varied within a certain angular range, for example to modify the amplitude and/or phase shift of the traveling wave. The angle range can be, for example, plus/minus 40 degrees, preferably plus/minus 30 degrees, in particular plus/minus 20 degrees, particularly preferably plus/minus 10 degrees, in particular plus/minus 5 degrees.

The rotary drive can, for example, comprise an electric motor with a rotating drive shaft and a transmission that is designed to convert the rotational movement of the drive shaft into corresponding rotational movements of the individual permanent magnets. The transmission can, for example, comprise gears, belts and/or chains that couple the axes of rotation of the permanent magnets to one another and/or to the drive shaft in a form-fitting and/or force-fitting manner. The synchronization of the rotational movements of the individual permanent magnets can thus be achieved via the transmission.

Alternatively, an embodiment is conceivable in which each permanent magnet is rotated by its own electric motor. This has the advantage that the permanent magnets can be controlled independently of one another. In this case, synchronization can be achieved by correspondingly simultaneous control of the individual electric motors, for example by a higher-level elevator control system.

The linear drive can also comprise more than one magnetic track and/or more than one force-transfer member. For example, when the elevator system is in the operational state, the magnetic track and the force-transfer member can be arranged on opposite sides of the elevator car. However, a one-sided drive of the elevator car is also possible.

According to one embodiment, the rotary drive can be designed to rotate adjacent permanent magnets of the same row such that the magnetic fields of the rotating adjacent permanent magnets of the same row are offset, relative to one another, in their orientation by 90 degrees. Here and in the following, “orientation” can be understood as a magnetization direction in which the permanent magnet is magnetized. In this way, it can be achieved, for example, that the traveling field is increased on a side of the magnetic track facing the force-transfer member, and/or reduced on a side of the magnetic track facing away from the force-transfer member. This has the advantage that smaller permanent magnets can be used, without necessarily reducing the resulting magnetic forces.

According to one embodiment, the orientation of the magnetic field of each rotating permanent magnet, preceded by a rotating adjacent permanent magnet of the same row and followed by a rotating adjacent permanent magnet of the same row, is equal to an orientation of the magnetic field of the preceding permanent magnet that is rotated 90 degrees clockwise, and equal to an orientation of the magnetic field of the following permanent magnet that is rotated 90 degrees counterclockwise. The magnetic track can thus be realized as a Halbach array or quasi-Halbach array. For example, the orientations in a reference position can have the following order: left, up, right, down, left, up, etc. The orientations can also follow one another in reverse order. Starting from the reference position, the permanent magnets can then be rotated so that the initial alignment of adjacent orientations relative to one another is maintained during the rotational movement of the permanent magnets. As mentioned above, a (minor) variation of the angular deviations during the rotational movement of the permanent magnets is also possible.

According to one embodiment, the rotary drive can be designed to rotate adjacent permanent magnets of the same row such that the magnetic fields of the rotating adjacent permanent magnets of the same row have opposite orientations, i.e. differ from one another by 180 degrees. This can be the case, for example, if the force-transfer member is arranged in the overlap region between a first row and a second row of permanent magnets (see also below) and the axes of rotation of the permanent magnets of the first row are offset towards the displacement axis, relative to the axes of rotation of the permanent magnets of the second row, for example are offset centrally, so that viewed in the direction of the displacement axis-the distance between adjacent axes of rotation of different rows is equal to half the distance between adjacent axes of rotation of the same row.

According to one embodiment, the magnetic track may comprise a first row and a second row of permanent magnets. The force-transfer member can be arranged in the overlap region between the first row and the second row, i.e. it can run through an air gap between the first row and the second row. In this case, the rotary drive can be designed to rotate adjacent permanent magnets of different rows in such a way that the magnetic fields of the rotating adjacent permanent magnets of different rows are offset, relative to one another, in their orientation by a defined angle. For example, the first row can contain exactly the same number of permanent magnets as the second row. Alternatively, the first and second rows may contain different numbers of permanent magnets. As mentioned above, the first and second rows can be offset from one another (see also below). A design is also possible in which the permanent magnets of different rows—viewed transversely to the displacement axis—are arranged opposite one another in pairs, the permanent magnets of the same pair, more precisely their axes of rotation, having the same longitudinal position with respect to the displacement axis, and the permanent magnets of different pairs having different longitudinal positions with respect to the displacement axis. The rotary drive can, for example, be designed to drive the permanent magnets of the first row independently of the permanent magnets of the second row.

According to one embodiment, the defined angle can be 0 degrees, 90 degrees or 180 degrees. In the event that the first and the second row are each designed as a (quasi-) Halbach array and the permanent magnets of different rows are arranged opposite one another in pairs (see above), for example the orientations of the magnetic fields of adjacent permanent magnets of different rows can be alternately offset relative to one another by 180 degrees and 0 degrees, i.e. alternately non-rectified and rectified. In the event that the axes of rotation of different rows are offset from one another in the direction of the displacement axis (see above), the orientations of the magnetic fields of adjacent permanent magnets of different rows can be offset from one another by 90 degrees, for example. In this case, for example the magnetic fields of adjacent permanent magnets in the same row can be opposite in orientation.

According to one embodiment, the axes of rotation of the permanent magnets of the first row can be offset towards the displacement axis, relative to the axes of rotation of the permanent magnets of the second row. For example, the axes of rotation of the permanent magnets of the first row can be centrally offset relative to the axes of rotation of the permanent magnets of the second row, in the direction of the displacement axis. In other words, viewed in the direction of the displacement axis, the distance between adjacent axes of rotation of different rows can be equal to half the distance between adjacent axes of rotation of the same row.

According to one embodiment, the rotary drive can be designed to rotate the permanent magnets of the first row at a different rotational speed and/or in a different rotational direction from the permanent magnets of the second row. In principle, all permanent magnets in the same row should be rotated at the same rotational speed and in the same rotational direction. In order to obtain the desired superposition of the magnetic fields in the form of the traveling wave, the permanent magnets of the first row can be rotated in a rotational direction opposite to the rotational direction of the permanent magnets of the second row. For example, by changing the rotational speed of the permanent magnets in the first row (which rotate at the same speed) compared to the rotational speed of the permanent magnets in the second row (which rotate at the same speed), a phase-shifted traveling wave can be generated.

According to one embodiment, the rotary drive can be designed to rotate the permanent magnets of the same row simultaneously, at the same rotational speed and/or in the same rotational direction. In this way, the amplitude of the traveling wave can be kept more constant.

According to one embodiment, the permanent magnets of the same row may comprise first permanent magnets and second permanent magnets alternately. In this case, the rotary drive can be designed to rotate the first permanent magnets independently of the second permanent magnets. In other words, viewed in the direction of the displacement axis, there can always be at least one second permanent magnet arranged between two first permanent magnets, and/or at least one first permanent magnet arranged between two second permanent magnets. The rotary drive can therefore be designed to rotate the first permanent magnets at a different rotational speed and/or in a different rotational direction from the second permanent magnets. In addition, the rotary drive can be designed to rotate all first permanent magnets simultaneously at the same rotational speed and/or in the same rotational direction, and/or to rotate all second permanent magnets simultaneously at the same rotational speed and/or in the same rotational direction. In addition, the rotary drive can be designed to rotate the first permanent magnets together with the second permanent magnets.

According to one embodiment, the permanent magnets can be divided, in the direction of their axes of rotation, into at least two cylindrical segments of different polarity. The segments can, for example, be separated from one another by an air gap. The segments can be connected to each other in a torsionally rigid manner. In other words, the segments can be coupled together in such a way that one segment is always rotated at the same rotational speed and in the same rotational direction as the other segment or segments. This makes it possible to reduce drive force fluctuations of the linear drive.

According to one embodiment, the axes of rotation can run parallel to each other and/or orthogonally to the displacement axis.

According to one embodiment, the force-transfer member can be designed in a ladder-like form with a plurality of rungs. For example, in their longitudinal direction the rungs can in each case run transversely or diagonally to the longitudinal direction of the ladder-like force-transfer member. The rungs can be separated from one another in each case by air gaps. For example, the force-transfer member can resemble a squirrel-cage rotor, as used for asynchronous machines. The weight of the force-transfer member can thus be reduced.

Additionally or alternatively, the force-transfer member can be formed by a magnetically soft structure which in particular has slots. The slots make it possible to locally change the magnetic properties of the force-transfer member, comparable to the rotor of a reluctance motor.

Additionally or alternatively, the force-transfer member can be designed like a plate or band. For example, a force-transfer member in the form of a flexible metal belt, band or plate is possible, which, when the linear drive is in the operational state, runs at least in part along the displacement axis through the elevator shaft. The plate-or band-like force-transfer member can optionally have a plurality of through-openings, for example in the form of slots arranged in a row in the direction of the displacement axis, in order to locally change the magnetic properties of the force-transfer member, comparable to the rotor of a reluctance motor.

According to one embodiment, a gap between adjacent rungs can be filled at least in part with a magnetically soft material. The magnetically soft material can be, for example, (soft) iron, steel, a nickel-iron, cobalt-iron or aluminum-iron alloy. The magnetic properties of the force-transfer member can thus be further improved.

Advantageous embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to one embodiment of the invention.

FIG. 2 shows a portion of a linear drive according to an embodiment of the invention with a single-row magnetic track.

FIG. 3 shows a portion of a linear drive according to an embodiment of the invention with a two-row magnetic track whose permanent magnets are arranged opposite one another in pairs.

FIG. 4 shows a portion of a linear drive according to an embodiment of the invention with a two-row magnetic track whose permanent magnets are offset from one another.

FIG. 5 shows a portion of a linear drive according to an embodiment of the invention with a plurality of two-row magnetic tracks.

FIG. 6 shows a portion of a ladder-like force-transfer member of a linear drive according to an embodiment of the invention.

The drawings are merely schematic, and not to scale. Like reference signs refer in different drawings to like or analogous features.

### DETAILED DESCRIPTION

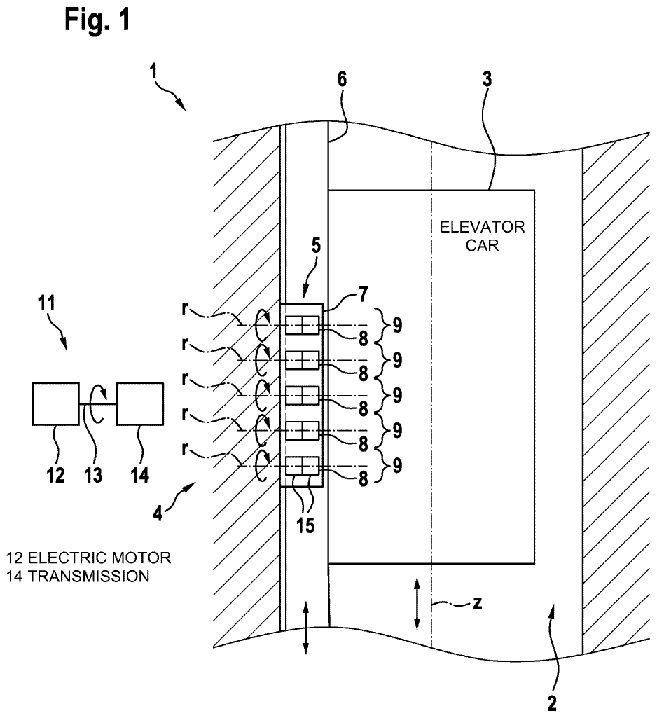

FIG. 1 shows an elevator system 1 in whose elevator shaft 2 an elevator car 3 is mounted so as to be movable in the direction of a vertical displacement axis z, between different floors of a building. A horizontal or inclined displacement axis z is also possible.

The elevator car 3 is driven by a linear drive 4, which comprises at least one magnetic track 5 and at least one force-transfer member 6 made of an electrically conductive material, for example a metal material such as iron, steel or aluminum.

The magnetic track 5 is formed by one or more carriers 7 in which a plurality of permanent magnets 8 are arranged in a row and mounted in each case so as to be rotatable about their own axis of rotation r. The permanent magnets 8 can be arranged in one or more rows.

The magnetic track 5 can, as shown by way of example in FIG. 1, be fixed to a side wall of the elevator shaft 2 via the carrier 7, while the force-transfer member 6 can be fixed laterally to the elevator car 3. However, an embodiment is also possible in which, conversely, the carrier 7 is fixed to the elevator car 3, while the force-transfer member 6 is fixed to the side wall of the elevator shaft 2.

In both cases, the magnetic track 5 and the force-transfer member 6 are arranged such that the permanent magnets 8, which belong to the same row, are lined up in the direction of the displacement axis z, i.e. vertically here, and the magnetic track 5 and the force-transfer member 6 are opposite one another in an overlap region 9.

In the overlap region 9, the permanent magnets 8 and the force-transfer member 6 are each separated from one another by an air gap (not shown) which is dimensioned such that the permanent magnets 8 and the force-transfer member 6 are in magnetic interaction with one another.

Because the force-transfer member 6 is fixed to the elevator car 3, it can be displaced together with the elevator car 3, i.e. the magnetic track 5 and the force-transfer member 6 can be displaced relative to one another in the direction of the displacement axis z, here in the vertical direction.

The axes of rotation r of the permanent magnets 8 of the same row can, for example, lie in a common vertical plane and in this case be aligned parallel to one another, i.e. run horizontally and thus orthogonally to the (vertical) displacement axis z.

If the magnetic track 5 comprises a plurality of rows of permanent magnets 8 (see also FIG. 3 to FIG. 5), the axes of rotation r of different rows can, for example, lie in two or more than two parallel vertical planes and each run horizontally.

The permanent magnets 8 are each magnetized in a specific magnetization direction (the magnetization direction can be understood as an orientation of a magnetic field generated by the respective permanent magnet 8).

If the permanent magnets 8 are cylindrical bar magnets, the magnetization direction of each permanent magnet 8 can, for example, be orthogonal to the longitudinal or central axis of the permanent magnet 8. In this case, the longitudinal or central axis can correspond to the axis of rotation r of the permanent magnet 8.

In order to generate a magnetic field moving in the direction of the axis of displacement z, in this case either from bottom to top or from top to bottom, which causes a corresponding displacement of the force-transfer member 6 relative to the magnetic track 5 and thus of the elevator car 3, the linear drive 4 comprises a rotary drive 11 which is designed to set the permanent magnets 8 in rotational movements in a suitable manner, i.e. in such a way that the superposition of the magnetic fields of the rotating permanent magnets 8 results in a traveling field moving along the magnetic track 5, i.e. in this case vertically, in magnetic interaction with the force-transfer member 6.

The rotary drive 11 can, for example, be arranged at least in part outside the elevator shaft 2. Mechanical or thermal influences of the rotary drive 11 on components of the elevator system 1 located in the elevator shaft 2 can thus be reduced.

In principle, the rotary drive 11 can comprise an electric motor 12 with a rotating drive shaft 13, which can be coupled to the individual permanent magnets 8 via a transmission 14. The electric motor 12 can, for example, be arranged outside the elevator shaft 2. In this case, the transmission 14 can be arranged partly outside and partly inside the elevator shaft 2.

For example, the rotary drive 11 can be designed to rotate the permanent magnets 8 of the same row simultaneously in the same direction of rotation and at the same rotational speed. It is thus possible to achieve that the permanent magnets 8 maintain their initial orientation relative to one another in the rotating state.

Optionally, each permanent magnet 8 can be divided, in the direction of its axis of rotation r, into two cylindrical segments 15 of different polarity, i.e. into a north pole and a south pole segment.

The two segments 15 can, for example, be separated from one another by an axial air gap. This configuration makes it possible to reduce the torque ripple required for the drive, i.e. the rotation of the permanent magnets 8.

Contrary to the illustration shown in FIG. 1, the magnetic track 5 and the force-transfer member 6 can be arranged on opposite sides of the elevator car 3. In other words, the elevator car 3 can be driven on both sides by the linear drive 4.

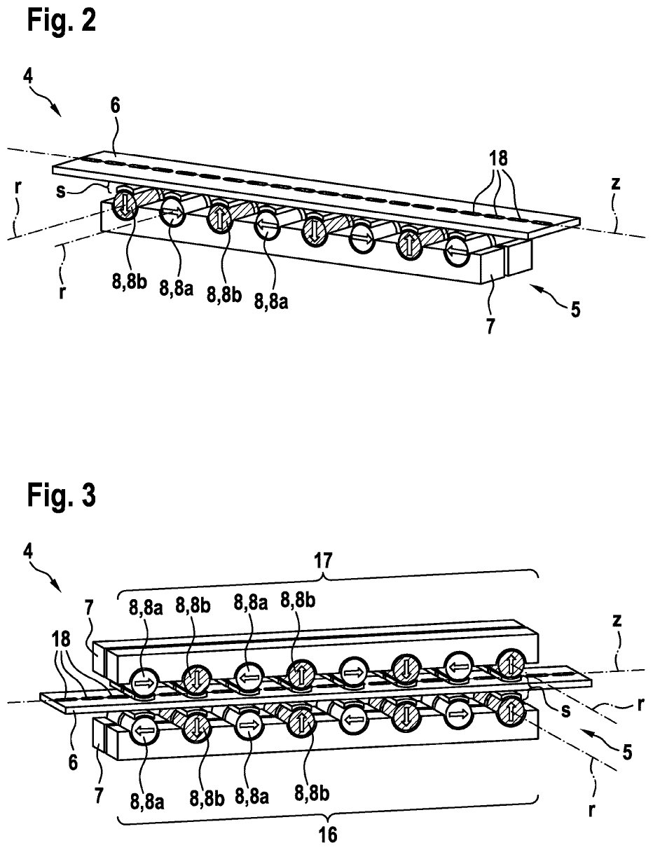

FIG. 2 shows a portion of a linear drive 4 in which the permanent magnets 8 are arranged only in one row and opposite the same side of the force-transfer member 6. In this case, the permanent magnets 8 are each separated from the force-transfer member 6 by an air gap s.

In this example, the permanent magnets 8 are aligned in a reference position relative to one another, in which the orientations (indicated by arrows in FIG. 2 to FIG. 4) of the magnetic fields of adjacent permanent magnets 8 are each offset from one another by 90 degrees.

In particular, the permanent magnets 8 can be aligned with one another, in the reference position, such that the orientation of the magnetic field of each permanent magnet 8, which is preceded by an adjacent permanent magnet 8 and followed by an adjacent permanent magnet 8, is equal to an orientation of the magnetic field of the preceding permanent magnet 8 rotated by 90 degrees clockwise and equal to an orientation of the magnetic field of the following permanent magnet 8 rotated by 90 degrees counterclockwise. The force-transfer member 6 thus floats above the magnetic track 5.

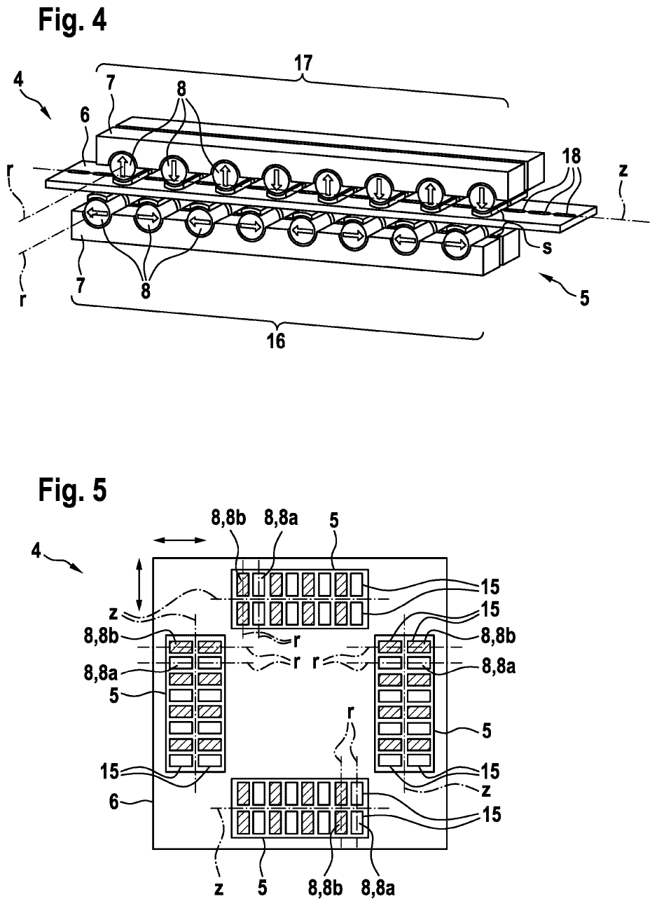

By arranging the permanent magnets 8 with mutually orthogonal magnetization directions on only one side, the manufacturing costs can be reduced compared to a two-row magnetic track 5 (see FIG. 3 and FIG. 4). In addition, this allows a greater freedom of movement of the force-transfer member 6 transversely to the displacement axis z.

FIG. 3 shows a portion of a linear drive 4 with a first row 16 of permanent magnets 8 and a second row 17 of permanent magnets 8, which is opposite the first row 16. In this case, the force-transfer member 6 can extend in an air gap s between the two rows 16, 17.

Here, the permanent magnets 8 are aligned with one another in a reference position in which, on the one hand, the orientations of the magnetic fields of adjacent permanent magnets 8 of the first row 16 are orthogonal to one another and, on the other hand, the orientations of the magnetic fields of adjacent permanent magnets 8 of the second row 17 are orthogonal to one another.

The permanent magnets 8 are also arranged in pairs so that-viewed transversely to the displacement axis z-each permanent magnet 8 of the first row 16 is opposite exactly one of the permanent magnets 8 of the second row 17.

Furthermore, the permanent magnets 8 of each row 16, 17 can comprise first permanent magnets 8a and second permanent magnets 8b which alternate, viewed in the direction of the displacement axis z. In this case, each first permanent magnet 8a of the first row 16 can be opposite exactly one of the first permanent magnets 8a of the second row 17. This may apply analogously to the second permanent magnets 8b.

In this case, the reference position can be such, for example, that the magnetic fields of the first permanent magnets 8a of the same longitudinal position with respect to the displacement axis z have opposite orientations, i.e. offset by 180 degrees from one another, parallel to the displacement axis z, and the magnetic fields of the second permanent magnets 8b of the same longitudinal position with respect to the displacement axis z have orientations that are aligned with one another, i.e. offset by 0 degrees from one another, orthogonally to the displacement axis z. The arrangement of the permanent magnets 8, 8a, 8b shown in FIG. 3 can also be referred to as a (quasi-) Halbach array.

In other words, by appropriate rotation of the permanent magnets 8, 8a, 8b, two pulsating magnetic fields aligned orthogonally to one another can be generated, which superimpose to form a traveling wave, i.e. a traveling magnetic wave. The control of the traveling wave in terms of commutation angle and amplitude can be largely similar to the control in conventional machines using phase currents projected onto two mutually orthogonal axes via the dq0 decomposition (direct-quadrature-zero transformation).

The dq0 decomposition of the currents makes it possible to control the driving and attractive forces independently of one another, via the quadrature and direct currents, respectively. Controlling the direct current also makes field weakening possible, in order to extend the speed range of the electrical machine. A similar technique can also be applied here, albeit with limitations, but in a mechanical rather than electrical way.

Since the pulsating fields of the two rows 16, 17 are orthogonal, a mechanical change in their relative phase shift has a similar effect to the change in the quadrature and direct currents. One difference can be seen in the fact that the amplitudes of the pulsating fields in coil-based electrical machines can be controlled independently of one another via the current, which is not the case here. In order to nevertheless allow a better control via the amplitude of the two pulsating fields, the first permanent magnets 8a can be driven independently of the second permanent magnets 8b of the same row 16 or 17.

FIG. 4 shows a two-row arrangement of the permanent magnets 8, in which the permanent magnets 8 of the first row 16 are arranged offset from the permanent magnets 8 of the second row 17, in the direction of the displacement axis z, in such a way that—viewed in the direction of the displacement axis z—between adjacent permanent magnets 8 of one row 16 or 17 there is exactly one of the permanent magnets 8 of the other row 16 or 17.

In this case, the reference position can, for example, be such that the magnetic fields of adjacent permanent magnets 8 of the first row 16 have opposite orientations parallel to the displacement axis z, and the magnetic fields of adjacent permanent magnets 8 of the second row 17 have opposite orientations orthogonal to the displacement axis z.

This also makes a field-oriented control of the linear drive 4 possible, as is realized in conventional electrical machines, by controlling the current components of the coil current.

In other words, the second row 17, hereinafter referred to as the upper armature, may have a vertically oriented, alternating north-south magnetization pattern. When the permanent magnets 8 of the upper armature all rotate synchronously and in the same direction, the force-transfer member 6 is exposed to a pulsating magnetic field.

The first row 16, hereinafter referred to as the lower armature, can be constructed similarly to the upper armature, with the difference that the north-south magnetization pattern is aligned horizontally here, i.e. shifted by 90 degrees to the magnetization pattern of the upper armature.

In addition, the axes of rotation r of the permanent magnets 8 belonging to the lower armature 16 are horizontally shifted relative to the axes of rotation r of the permanent magnets 8 belonging to the upper armature 17, so that they are located exactly in the middle between adjacent permanent magnets 8 of the upper armature.

When the permanent magnets 8 of the lower armature are rotated synchronously with those of the upper armature, but in the opposite rotational direction, the force-transfer member 6 is exposed to an additional pulsating magnetic field which now emanates from the lower armature. The two pulsating magnetic fields overlap to form a traveling wave, the direction of movement of which is determined by the rotational direction of the permanent magnets 8 in the two armatures.

The angle between the alignment of the magnetization patterns of the upper and lower armatures is kept at 90 degrees, under rotation, in this example. However, this is not absolutely necessary. By varying this angle, the traveling wave can be modified in a similar way to field-oriented control. Instead of changing the direct and the quadrature current, here the angle between the upper and lower magnetization patterns is changed, in order to achieve a similar purpose. In this way, the attraction and propulsion forces can be controlled.

It should be noted that the reference positions described above can refer to a rotating and/or a non-rotating state of the permanent magnets 8, 8a, 8b.

The rotary drive 11 can be designed to rotate the permanent magnets 8 such that the reference position related to the non-rotating state is maintained in the rotating state or is varied within certain limits.

For example, the rotary drive 11 can be designed to rotate the permanent magnets 8 of the first row 16 in a different rotational direction and/or at a rotational speed different from the permanent magnets 8 of the second row 17.

Additionally or alternatively, the rotary drive 11 can be designed to drive the first permanent magnets 8a of each row 16, 17 independently of the second permanent magnets 8b of the same row 16 or 17.

The single-row embodiment of the magnetic track 5 shown in FIG. 2 can also comprise alternating first permanent magnets 8a and second permanent magnets 8b, it being possible for the first permanent magnets 8a to be rotatable independently of the second permanent magnets 8b. The control of the floating and propulsion forces can thus be achieved by controlling the angles and rotational speeds of the two permanent magnet sets.

As shown in FIG. 2 to FIG. 5, the force-transfer member 6 can be designed, for example, in the form of a band or a plate. In addition, the band-or plate-shaped force-transfer member 6 can have a series of, for example, slot-shaped openings 18 for influencing the magnetic flux.

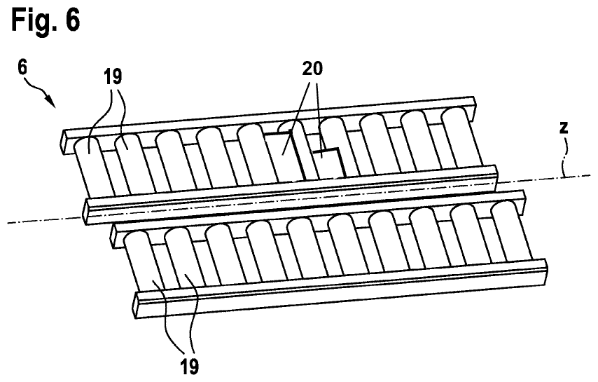

Alternatively, the force-transfer member 6 can be designed like a ladder with a plurality of rungs 19, as shown in FIG. 6. In the case of an asynchronous machine, the force-transfer member 6 can be formed, for example, by a double, unrolled, cage-like or ladder-like structure made of electrically conductive material.

The gaps between the rungs 19 may be empty or, optionally, filled at least in part with a magnetically soft material 20.

Alternatively, in the case of a synchronous reluctance machine, the force-transfer member 6 can be formed by a magnetically soft structure which can have corresponding slots in order to locally change the magnetic properties, i.e. the reluctance.

FIG. 5 shows an embodiment with four magnetic tracks 5 with mutually orthogonal longitudinal axes, which are arranged opposite the same side of the force-transfer member 6 and are each separated from it by an air gap. This makes possible a displacement of the force-transfer member 6 in mutually orthogonal directions (indicated by two double arrows).

The four magnetic tracks 5 can optionally be arranged on both sides of the force-transfer member 6, it being possible for the magnetic tracks 5 of different sides to be arranged opposite one another in pairs. The linear drive 4 can thus comprise a total of eight magnetic tracks 5.

Finally, it should be noted that terms such as “having,” “comprising,” etc. do not exclude other elements or steps, and indefinite articles such as “a” or “an” do not exclude a plurality. Furthermore, it is noted that features or steps described with reference to one of the preceding embodiments can also be used in combination with features or steps described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A linear drive for an elevator system, the elevator system including an elevator shaft and an elevator car movable in a displacement axis direction in the elevator shaft, the linear drive comprising:
a magnetic track having at least one row of permanent magnets mounted in a carrier, each of the permanent magnets having an axis of rotation and being rotatable about the axis of rotation;
a force-transfer member formed of an electrically conductive material;
wherein one of the magnetic track and the force-transfer member is fixed to the elevator shaft and another of the magnetic track and the force-transfer member is fixed to the elevator car;
wherein the permanent magnets in the at least one row are arranged one adjacent another in the displacement axis direction;
wherein the magnetic track and the force-transfer member are displaceable relative to each other in the displacement axis direction;
wherein the magnetic track and the force-transfer member lie opposite one another in an overlap region, and ones of the permanent magnets located in the overlap region are separated by an air gap from a portion of the force-transfer member lying opposite; and
a rotary drive rotating the permanent magnets such that a traveling field moving in the displacement axis direction is generated by superposition of magnetic fields of the rotating permanent magnets, the traveling field displacing the force-transfer member relative to the magnetic track in the displacement axis direction.

17. The linear drive according to claim 16 wherein the rotary drive rotates adjacent ones of the permanent magnets in the at least one row such that orientations of the magnetic fields of the rotating adjacent permanent magnets are offset relative to one another by 90 degrees.

18. The linear drive according to claim 17 wherein the orientation of the magnetic field of each of the rotating permanent magnets, preceded by an adjacent one of the rotating permanent magnets and followed by another adjacent one of the rotating permanent magnets, is equal to an orientation of the magnetic field of the preceding rotating permanent magnet that is rotated 90 degrees clockwise, and equal to an orientation of the magnetic field of the following rotating permanent magnet that is rotated 90 degrees counterclockwise.

19. The linear drive according to claim 16 wherein the rotary drive rotates adjacent ones of the permanent magnets in the at least one row such that orientations of the magnetic fields of the rotating adjacent permanent magnets are opposite.

20. The linear drive according to claim 16 including:
wherein the magnetic track has a first row of the permanent magnets and a second row of the permanent magnets;
wherein the force-transfer member is arranged in the overlap region between the first row and the second row; and
wherein the rotary drive rotates adjacent ones of the permanent magnets in the first row and the second row such that the magnetic fields of the rotating adjacent permanent magnets are offset relative to one another in orientation by a defined angle.

21. The linear drive according to claim 20 wherein the defined angle is 0 degrees, 90 degrees or 180 degrees.

22. The linear drive according to claim 20 wherein the axes of rotation of the permanent magnets in the first row are offset towards the displacement axis relative to the axes of rotation of the permanent magnets in the second row.

23. The linear drive according to claim 20 wherein the rotary drive rotates the permanent magnets in the first row at a different rotational speed and/or in a different rotational direction from rotation of the permanent magnets in the second row.

24. The linear drive according to claim 16 wherein the rotary drive rotates the permanent magnets in the at least one row simultaneously at a same rotational speed and/or in a same rotational direction.

25. The linear drive according to claim 16 wherein the permanent magnets in the at least one row include first permanent magnets alternating with second permanent magnets, and wherein the rotary drive rotates the first permanent magnets independently of the second permanent magnets.

26. The linear drive according to claim 16 wherein the permanent magnets are divided, in a direction of the axes of rotation, into at least two cylindrical segments of different polarity.

27. The linear drive according to claim 16 wherein the axes of rotation run parallel to each other and/or orthogonally to the displacement axis.

28. The linear drive according to claim 16 wherein the force-transfer member is formed as a ladder with a plurality of rungs, the rungs extending orthogonally to the displacement axis.

29. The linear drive according to claim 28 wherein a gap between adjacent rungs is filled at least in part with a magnetically soft material.

30. The linear drive according to claim 16 wherein the force-transfer member is formed as a soft magnetic structure having slots.

31. The linear drive according to claim 30 wherein the slots are arranged in a row extending in the displacement axis direction.

32. An elevator system comprising:
an elevator shaft;
an elevator car movable in a direction of a displacement axis in the elevator shaft; and
a linear drive according to claim 16 wherein either the magnetic track is fixed to the elevator shaft and the force-transfer member is fixed to the elevator car, or the force-transfer member is fixed to the elevator shaft and the magnetic track is fixed to the elevator car.
